(19) United States
(12) Patent Application Publication
(10) Pub. No.: US 2015/0239725 A1
(43) Pub. Date: Aug. 27, 2015

(54) SYSTEM FOR DISPENSING BEVERAGE

(71) Applicant: Wickwar Brewing Company Limited, Hambrook (GB)

(72) Inventors: Michael Samuel Thomas Watts, Chepstow (GB); Ian Tinsley Frost, West Yorkshire (GB); Michael Anthony Flavin, Bristol (GB); Leon Antony Farrel, Bristol (GB); Philip Anthony Atkinson, Derby (GB)

(73) Assignee: WICKWAR BREWING COMPANY LIMITED, Hambrook (GB)

(21) Appl. No.: 14/426,540

(22) PCT Filed: Sep. 6, 2013
(86) PCT No.: PCT/GB2013/052340

§ 371 Date: Mar. 6, 2015

Related U.S. Application Data
(60) Provisional application No. 61/739,440, filed on Dec. 19, 2012.

(30) Foreign Application Priority Data
Sep. 6, 2012 (GB) 1215943.0

(51) Int. Cl. B67D 1/10; B67D 1/08; B67D 1/00

(52) U.S. Cl. CPC B67D 1/10; B67D 1/0004; B67D 1/0082; B67D 1/0801; B67D 1/0857

(57) ABSTRACT

A system (2) for dispensing beverage, particularly cask ale, the system (2) comprising: a pump (4) configured for drawing cask ale by suction from a supply (6) into a pump inlet (18) and delivering cask ale from a pump outlet (26) under sustained pressure; a flow regulator (12) having an inlet (32) for receiving cask ale under sustained pressure from the pump outlet (26), and a flow regulator outlet (34) for delivering cask ale under a dispense pressure; and a dispense conduit (14) for receiving cask ale under dispense pressure from the flow regulator outlet (34) and turbulating and dispensing cask ale via the dispense outlet (48). Dispense methods and a valve nozzle are also described.

### FIELD OF THE INVENTION

This invention relates to systems, components and methods for dispensing beverages. In particular, though not exclusively, the invention relates to systems, components and methods for dispensing beverages that are cask conditioned and traditionally dispensed and served without the incorporation of extraneous gas from a pressurised source.

### BACKGROUND OF THE INVENTION

Many beverages are sold and stored in bulk, to be served by dispensing them from a supply at a serving location, for example in a drinking establishment such as a pub or bar, in gastronomy, or at home.

The form of the supply varies widely depending on the beverage, as do the systems and methods used for dispensing the beverage. One group of beverages is stored in containers in a storeroom and dispensed from the containers via dispensing lines leading to dispensing outlets. Such beverages are often of the fermented type, e.g. beers and ciders, but may also be non-alcoholic.

Many beverages, particularly some beers and ciders, are sold and stored in pressurised kegs, from which they are forced into dispensing lines by the introduction into the kegs of extraneous gas, such as carbon dioxide and/or nitrogen, from a pressurised source. After the beverage has been pushed into the dispensing line, an auxiliary pump is sometimes used to further pressurise the beverage in the dispensing lines. Fermented keg beverages, especially keg beer, are generally pasteurised, which means that no secondary fermentation occurs in the keg. There is hence no natural carbonation of keg beverages, which provides a further reason for introducing the extraneous gas into the keg: the gas “fizzes up” the beverage as it is forced out of the keg and into the dispensing lines. Whilst pasteurisation and pressurisation enhance storage life and the introduction of extraneous gas allows for fast and easy dispensing, many consider the taste and aroma of fermented keg beverages to be poor.

Cask beverages are beverages that undergo conditioning or secondary fermentation in the container in which they are supplied to a serving location. Cask beverages are typically cask beers, i.e. beverages produced by the saccharification of starch and fermentation of the resulting sugar. Commonly, they are ales made with a top-fermenting yeast. Examples of cask ales are bitters, milds, stouts, porters, barley wines, golden ales and old ales. For simplicity, unless specified otherwise, the term “cask ale” is used herein to embrace all cask beers, with the word “cask” embracing all suitable bulk vessels or containers in which such beverages can be supplied, without any structural limitation. Casks are typically unpressurised, though they may be under some autogenic pressure resulting from fermentation.

On account of secondary fermentation in the cask, cask ale is generally perceived to have an enhanced aroma and taste compared to keg beverages. At serving locations, cask ales are typically stored in their casks on a stillage in a temperature controlled environment e.g. for 24 hours, to allow active ingredients disturbed by the transit and delivery to settle out. Once the cask ale has settled, the cask is tapped to allow the cask ale to be served.

The traditional dispense method for cask ales is via a hand-pull whereby a hand operated lever is pulled to drive a “beer engine” that draws the ale by suction from the cask, stored typically in a cellar, to a dispense head via the beer engine and through a dispense outlet that is integrated into the hand pull/beer engine. No pressure is applied to the cask and no extraneous gas from a pressurised source is introduced. For any given system, the rate of dispense depends entirely on the speed of the hand pull. Generally several pulls are required to dispense a pint of ale. The ale is typically served at 11 to 13° C., this being the usual cellar temperature. Cask ale is traditionally not chilled. Depending on the type of dispense outlet utilised, the nature of the cask ale and the manner in which the hand-pull is operated, a foam head of between 2 mm-6 mm is often formed on a pint of dispensed cask ale and will dissipate over a short period, usually 1 to 2 minutes.

Whilst the traditional dispense method for cask ales is tried and tested and avoids applying pressure to the cask ale supply, it suffers from the drawback of being relatively slow. There are also limitations with regard to the nature of the foam head that can be formed. Finally, overspill is a common problem, particularly due to irregular dispense rates resulting from multiple pulls of the hand pull.

It is an object of the invention to provide systems, methods and components for addressing these problems.

### STATEMENTS OF THE INVENTION

According to a first aspect of the invention there is provided a system for dispensing beverage, particularly cask ale, the system comprising: a pump configured for drawing cask ale by suction from a supply into a pump inlet and delivering cask ale from a pump outlet under sustained pressure; a flow regulator having an inlet for receiving cask ale under sustained pressure from the pump outlet, and a flow regulator outlet for delivering cask ale under a dispense pressure; and a dispense conduit for receiving cask ale under dispense pressure from the flow regulator outlet and turbulating and dispensing cask ale via the dispense outlet.

Crucially, as the pump is configured for drawing ale from a supply by suction, the system avoids the need to introduce extraneous gas into the supply, which is important to preserve the aroma and taste of cask ales. This distinguishes the system from keg beer delivery systems in which extraneous gas is introduced into the supply.

The system allows cask ale to be dispensed rapidly and with consistent dispense results. In particular, the delivery of cask ale under sustained pressure from the pump to the flow regulator enables the dispense pressure to conform to dispense pressure profiles (i.e. pressure distributions over time) not available when dispensing cask ale by traditional means. Such dispense pressure profiles have in turn been found to enable improved dispense results from the dispense outlet, particularly following turbulation.

For example, on account of the sustained pressure from the pump, the dispense pressure may be kept substantially constant, without interruption, while dispensing a whole pint of ale, providing a more consistent flow rate than is achievable with a traditional hand pull. This helps to prevent overspill, speeds up the dispensing process and can also have a desirable impact on the consistency of any foam head formed.

Advantageously, the system may be configured, under a suitable dispense pressure profile, to serve cask ales rapidly, e.g. in under 10 seconds per pint, and/or with a tight foam head that is retained in a standard pint glass for several minutes, e.g. at least 5 minutes. A tight foam head has the advantage of retaining natural carbon dioxide in the ale underneath the head, helping to maintain flavour and aromas.

The system, and in particular its capability to dispense cask ale rapidly, is of particular benefit in the context of chilled cask ale. In general chilled cask ale tends to be less prone to the release of naturally entrained gas, such as carbon dioxide, than cask ale dispensed at ambient temperature and therefore generally settles with less foam head upon being dispensed. This in turn facilitates achieving or controlling a desired dispense result using the system of the invention, particularly where rapid dispensing is desired.

Given its particular synergy with chilled cask ale, the system may advantageously further comprise a chiller for chilling cask ale before it is dispensed via the dispense outlet. The chiller may, for example, be arranged to chill between the outlet of the pump and the inlet of the flow regulator. The chiller may suitably comprise refrigerant coils and cask ale conduits adjacent to each other in a heat transmitting medium so that heat from the cask ale flows into the refrigerant coils. Suitably, the chiller may be arranged to chill to a temperature in the range of from 2 to 8° C., preferably 3 to 6° C.

As aforesaid, the dispense pressure may conform to a dispense pressure profile. In particular, the flow regulator may be arranged to set the dispense pressure to conform to a predetermined dispense pressure profile.

A “dispense pressure profile” characterises dispense pressure over time. Preferably, a dispense pressure profile may characterise the dispense pressure over substantially all time at which cask ale is dispensed by the system. However, a dispense pressure profile may also characterise the dispense pressure over a more limited segment of time, e.g. the time taken to dispense a measure of cask ale (e.g. a pint) from the system, e.g. a period of 5, 6 7, 8, 9 or 10 seconds.

The dispense pressure profile may be predetermined such that the dispense pressure is kept substantially constant or within a particular pressure range (generally above atmospheric pressure), and/or to achieve a particular dispense rate during the relevant time. For example, the dispense pressure may be set such that a pint of cask ale is dispensed from the dispense outlet, preferably at a substantially constant flow rate, in less than 15 seconds, preferably less than 10 seconds. A substantially constant pressure or flow rate may be defined as varying by less than 30%, preferably less than 10% or even less than 5%. Consistency in dispense pressure and/or flow rate assists not only with rapid dispensing but can also help to form a foam head consistently and to prevent overspill, since surges in dispense associated with variable pressure, e.g. via a hand pull, are eradicated.

The dispense pressure profile may be predetermined to provide particular results in terms of a foam head of any particular cask ale. For example, the dispense pressure may be such that, when a pint of cask ale is dispensed from the dispense outlet into a standard pint glass, a tight foam head lasting at least 5 minutes is formed.

The ability to set a dispense pressure profile, by the provision of sustained pressure and the selection or configuration of the flow control means, enables the invention to achieve dispense results from the dispense outlet, particularly following turbulation, which have hitherto been unavailable by traditional dispense methods.

In a particularly preferred embodiment, the system is configured to dispense a chilled pint of cask ale with a tight foam head in under 10 seconds. A tight foam head may be defined as a foam head that persists for at least 4, preferably 5 minutes.

Particularly to facilitate such results, or indeed more generally, the system may be arranged such that the dispense pressure remains in the range of from 14 to 30 psi, preferably 16 to 28 psi, most preferably 18 to 24 psi.

The flow regulator may comprise a simple tap, optionally of the free flow type. The tap may be used as a means for stopping and starting dispense of ale from the dispense outlet and may be positioned and combined with other components to achieve a desired dispense pressure profile. However, more preferably, the flow regulator may comprise a pressure compensated flow control valve. Advantageously, such a flow control valve may be adjustable and/or set to output a desired dispense pressure. This is of particular benefit in the context of achieving a dispense pressure profile according to which the dispense pressure is kept substantially constant.

The pump is configured for delivering cask ale from its outlet under sustained pressure when actuated. Preferably, the pressure may be “sustained” in the sense that it persists both during one or more periods when cask ale is being dispensed from the system and one or more periods when cask ale is not being dispensed from the system. The pressure may be sustained, for example, for a period of at least one hour. Naturally, when the system is not active, the pressure need no longer be sustained.

The sustained pressure may preferably be substantially constant, though it may oscillate slightly with the action of the pump. The sustained pressure at which the pump delivers cask ale will typically be higher than the dispense pressure. A high delivery or discharge pressure at the pump provides for greater flexibility in transporting the cask ale via ale lines and setting the dispense pressure, particularly where an adjustable pressure compensated flow control valve is employed. Accordingly, the delivery pressure of the pump may preferably be at least twice, more preferably at least three times as high as the dispense pressure (measured in psi herein). For example, the pump may be configured to deliver cask ale under a discharge pressure of at least 40 psi, or even at least 80 psi. The pump may be of any suitable type but may conveniently be powered by pressurised gas or electricity. Preferably, the pump may be a diaphragm pump.

The dispense conduit may be of any suitable diameter and shape consistent with achieving a desired dispense of cask ale or other beverage. The dispense conduit may comprise a dispense tube. The dispense tube may, for example, have a length in the range of from 200 to 400 mm, e.g. 250 to 300 mm. Preferably, particularly in combination with the preferred dispense pressure profiles discussed hereinabove, the internal diameter of the tube may be in the range of from 7 to 12 mm, more preferably in the range of from 9 mm to 11 mm.

The dispense outlet may preferably be narrower than the internal diameter of the dispense tube. The dispense outlet may preferably comprise a plurality of apertures, e.g. at least 10, such as 20 to 30. Suitably the apertures may have a diameter of 0.1 to 1 mm, preferably 0.5 to 0.8 mm. In an embodiment of the invention, the dispense outlet is defined by a sparkler nozzle comprising a ring of apertures.

As aforesaid, the system may comprise a tap, which may be used as a means for stopping and starting dispense of cask ale from the dispense outlet. To provide additional or alternative control over the dispensing of cask ale, the system may further comprise a shutoff valve for selectively preventing flow of cask ale to the flow regulator.

In an embodiment of the invention, the system comprises a dispense valve, separate from the flow regulator and preferably any shutoff valve, operable to permit or prevent dispense of ale from the dispense outlet in an open or closed position respectively. The dispense valve may advantageously be located at or near the dispense outlet. Sustained pressure generated by the pump may act upon the dispense valve in the closed position and drive dispense of cask ale through the dispense valve in the open position. The dispense valve may be configured to be biased into the closed position by liquid pressure, e.g. the sustained pressure of the pump.

In such a configuration, the dispense valve is operable by a user against liquid pressure to dispense cask ale from the system.

Preferably, the dispense valve may be operable to permit dispense of cask ale at a first rate or at a second rate that is different from the first rate. Such operation is particularly useful in dispensing cask ale, for example when a glass is desired to be filled at a first, rapid rate and then to be topped up at a second, slower rate.

In a preferred embodiment of the invention, the dispense valve may be a valve nozzle according to a third aspect of the invention described hereinbelow.

The system may optionally include a supply of cask ale in fluid communication with the inlet of the pump. When installed, the system comprises a first conduit linking the supply with the inlet of the pump and a second conduit linking the outlet of the pump with the inlet of the flow regulator. The conduits may comprise one or more intermediate components, e.g. as described hereinabove.

The system is particularly suited to dispensing cask ale. Unlike a keg beer, cask ale will typically have undergone conditioning or secondary fermentation in a cask. Preferably the supply may be a cask. As aforesaid, the structure of a “cask” is not critical. However, the cask is not extraneously pressurised (though it may be under some autogenous pressure), and is distinct from a keg. The supply may hence suitably be an extraneously unpressurised supply.

The system may also be used to dispense other beverages instead of cask ale, if desired, e.g. other beers ciders or non-alcoholic drinks. All references to the dispensing of cask ale herein should be understood as such, and the invention embraces methods of using the system to dispense any desired beverage. Naturally, the system may be used to dispense any desired measure of a beverage. Preferably, the system may be used to dispense measures of at least half a litre, e.g. pints. A consistent and rapid dispense is of particular value in dispensing larger measures. Advantageously, the system may be operated to dispense ale into the bottom half of a glass or other vessel.

According to a second aspect of the invention, there is provided a method of dispensing beverage, e.g. cask ale, from a dispense nozzle in fluid communication with a supply of beverage, the method comprising: drawing a stream of beverage from the supply; pressurising the stream to force it along a transport conduit under sustained pressure; regulating the pressure of the transported stream to a dispense pressure; and turbulating and dispensing the stream from the dispense nozzle.

As this method may be used to operate the system of the first aspect of the invention, optional and preferred features thereof will be readily apparent from the above description.

According to a third aspect of the invention, there is provided a valve nozzle for dispensing liquid, in particular cask ale, the valve nozzle defining a flow path for liquid from an inlet to a nozzle outlet and comprising; a valve seat extending around the flow path; a valve head co-operable with the valve seat in a fully closed position to prevent flow of liquid along the flow path and out of the outlet; an actuator connected to the valve head, the actuator being movable in a first direction to move the valve head away from the fully closed position to allow liquid to flow past the valve seat and along the flow path, and being movable in a second direction different to the first direction; and deflecting means for translating movement of the actuator in the second direction into movement of the actuator in the first direction, such that movement of the actuator in the second direction causes the valve head to move away from the fully closed position to allow liquid to flow past the valve seat and along the flow path.

In an embodiment of the invention, the deflecting means is arranged to tilt the valve head out of the fully closed position when the actuator is moved in the second direction.

The first direction may be generally parallel to the flow path. The second direction may, for example, be substantially orthogonal to the first direction. Preferably, the second direction may be any direction chosen from a set of radial directions in a single plane.

In an embodiment of the invention, the actuator may comprise a stem connected to the valve head. The stem may comprise, or be connected to, a member accessibly clear of the flow path. The accessibly clear member may be moved by a user to cause the movement in the first or second directions. The member may advantageously comprise a panel, preferably a disc, which may be generally orthogonal to the stem.

In an embodiment of the invention, the stem may comprise the deflecting means. The deflecting means may comprise a formation that abuts a body of the valve when the valve head is in the fully closed position. Preferably, the formation may comprise a frustoconical section that abuts an internal shoulder of the valve body when the valve head is in the fully closed position. Advantageously, engagement between the frustoconical section and the internal shoulder of the nozzle body may translate movement of the actuator in the second direction into movement in the first direction.

The nozzle outlet may comprise a plurality of apertures, e.g. having a diameter of 0.1 to 1 mm, preferably 0.5 to 0.8 mm. In an embodiment of the invention, the nozzle outlet comprises at least 10 apertures, e.g. 12 to 20 apertures, preferably in a ring.

Throughout the description and claims of this specification, the words “comprise” and “contain” and variations of the words, for example “comprising” and “comprises”, mean “including but not limited to”, and do not exclude other moieties, additives, components, integers or steps. Moreover the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects, where context permits. Other features of the invention will become apparent from the following exemplary embodiments. Generally speaking the invention extends to any novel one, or any novel combination, of the features disclosed in this specification (including any accompanying claims and drawings). Thus features, integers or characteristics described in conjunction with a particular aspect, embodiment or example of the invention are to be understood to be applicable to any other aspect, embodiment or example described herein unless incompatible therewith. Moreover unless stated otherwise, any feature disclosed herein may be replaced by an alternative feature serving the same or a similar purpose.

Where upper and lower limits are quoted for a property, then a range of values defined by a combination of any of the upper limits with any of the lower limits may also be implied.

### SPECIFIC DESCRIPTION

Embodiments of the present invention will now be further described with reference to the accompanying figures, of which:

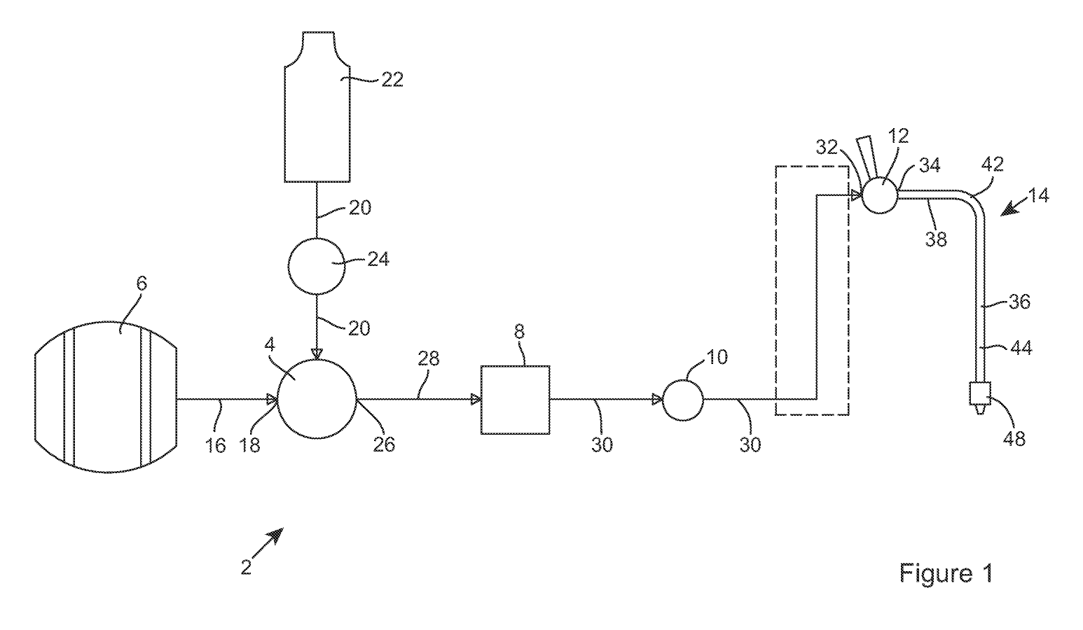

FIG. 1 shows a schematic view of a system for dispensing cask ale according to a first exemplary embodiment of the invention;

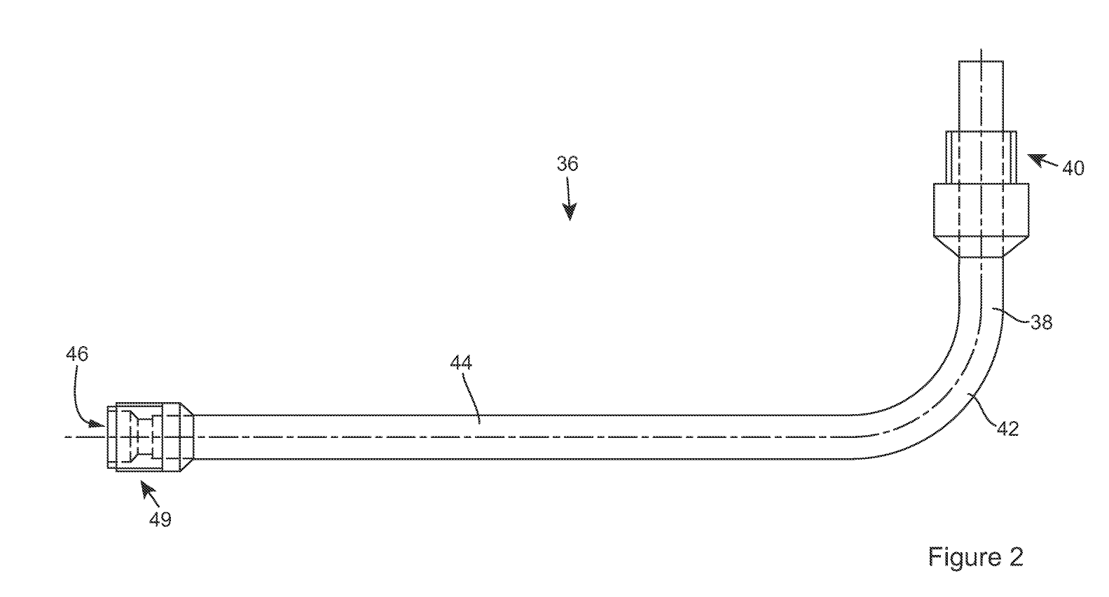

FIG. 2 shows a sectional view of a dispense tube of the system of FIG. 1;

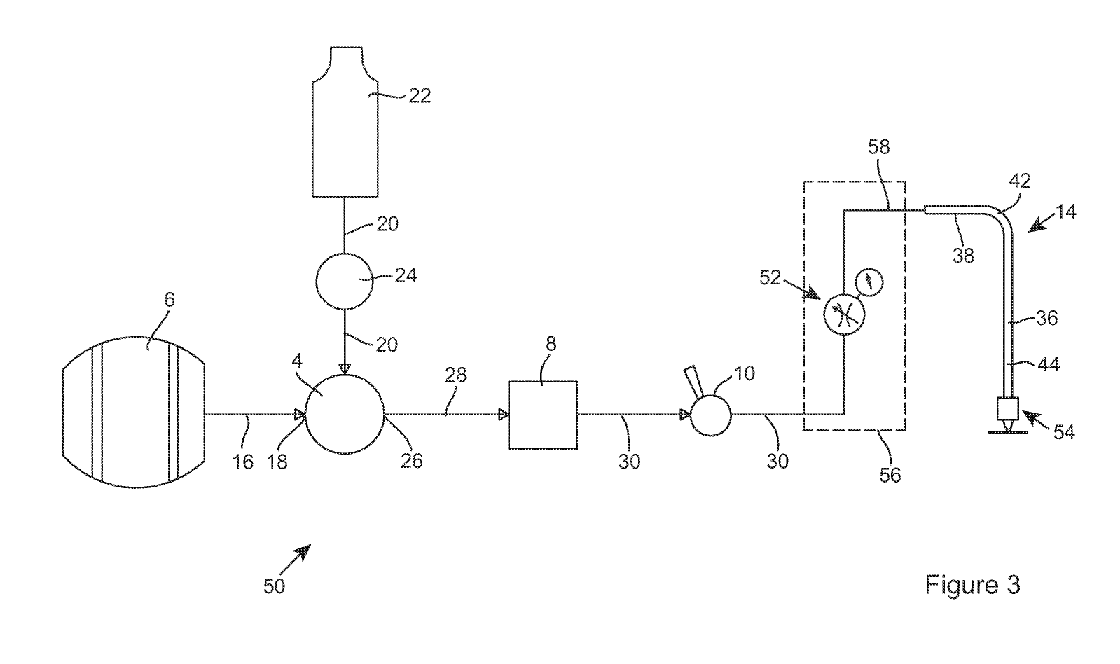

FIG. 3 shows a schematic view of a system for dispensing cask ale according to a second exemplary embodiment of the invention;

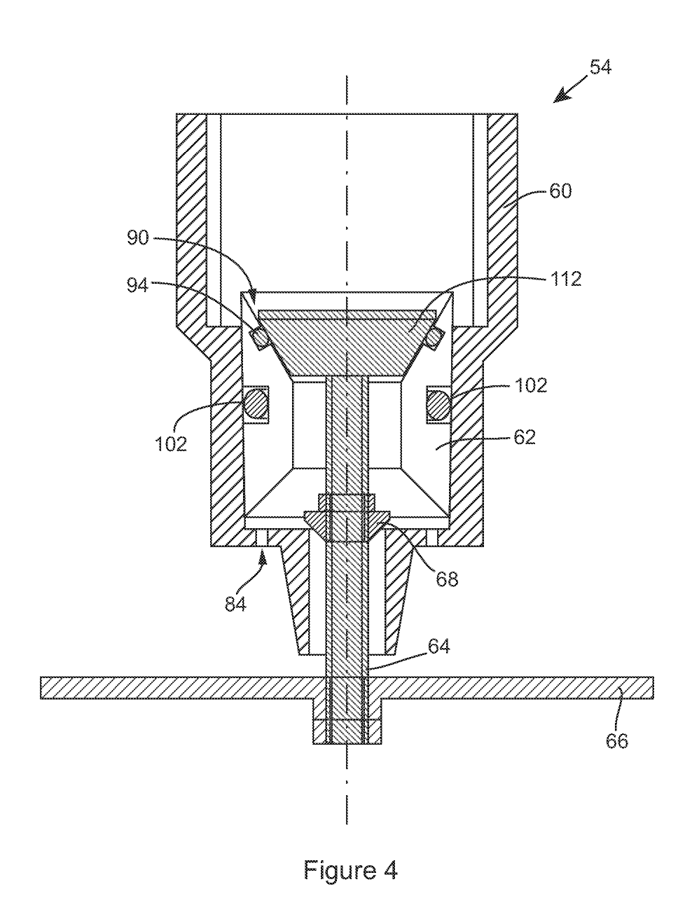

FIG. 4 shows a sectional view of a valve nozzle of the system of FIG. 3 in a closed position;

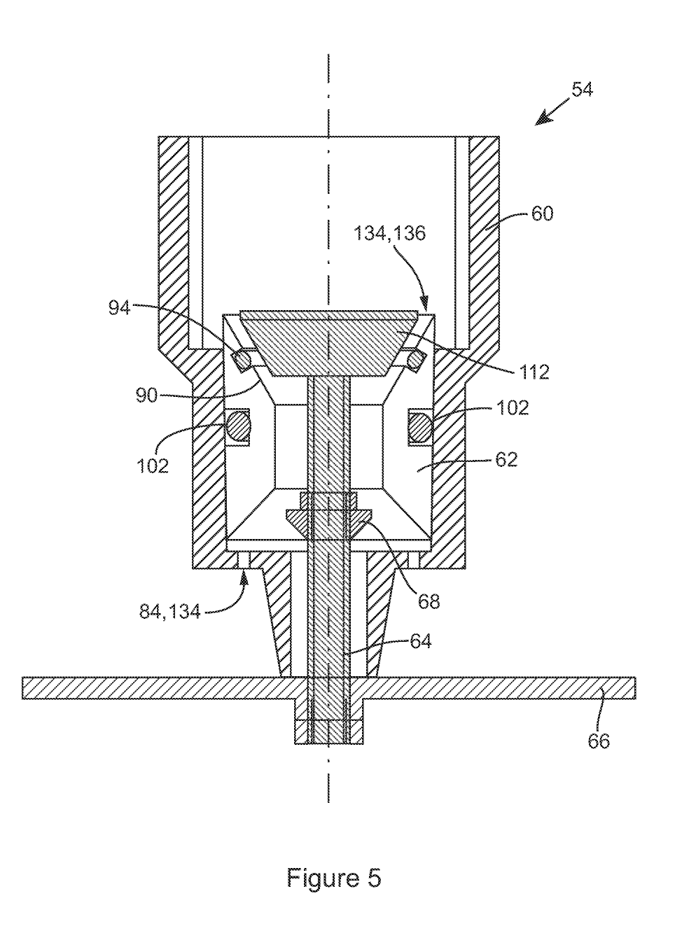

FIG. 5 shows a sectional view of a valve nozzle of the system of FIG. 3 in a fully open position;

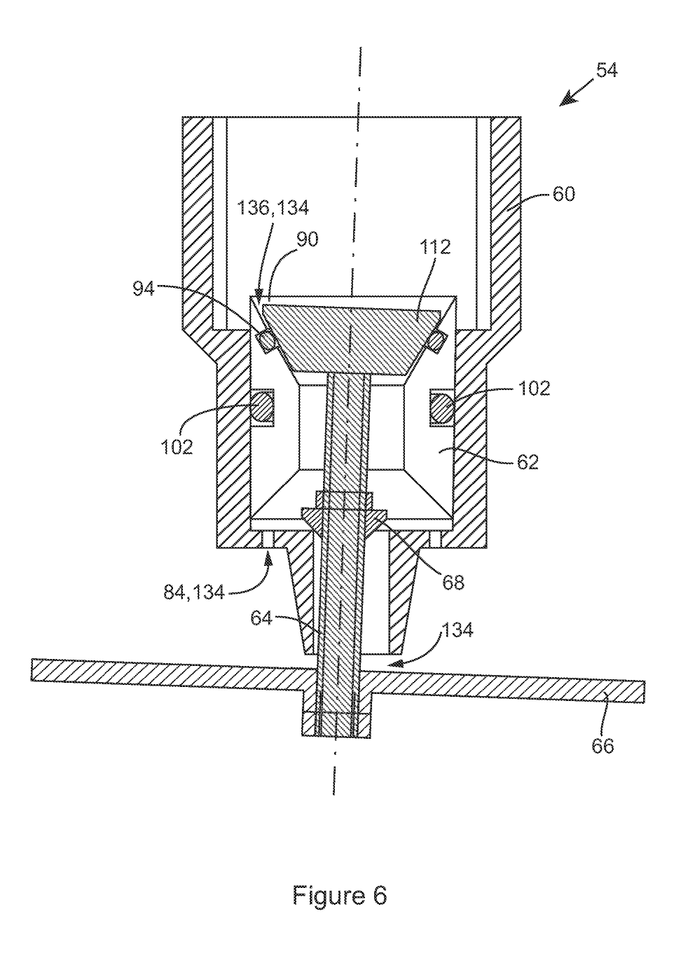

FIG. 6 shows a sectional view of a valve nozzle of the system of FIG. 3 in a partly open position;

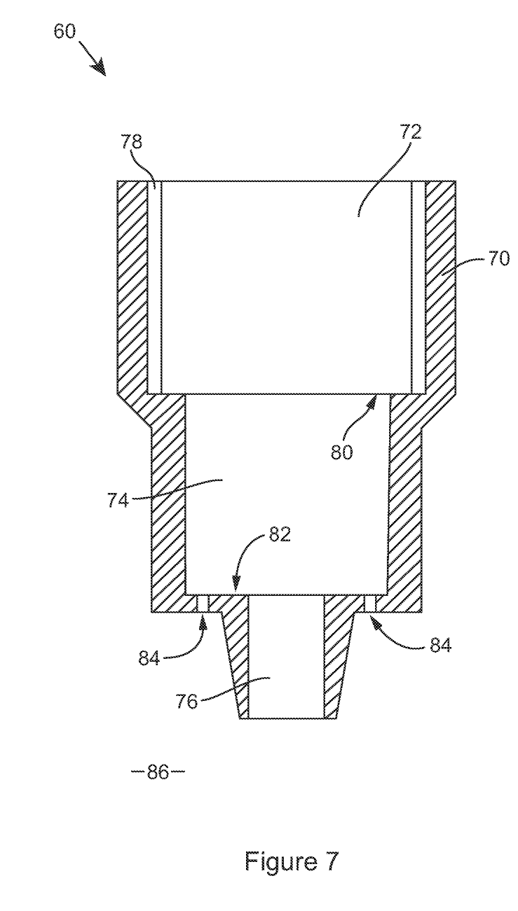

FIG. 7 shows a sectional view of a nozzle body of the valve nozzle of FIGS. 4 to 6;

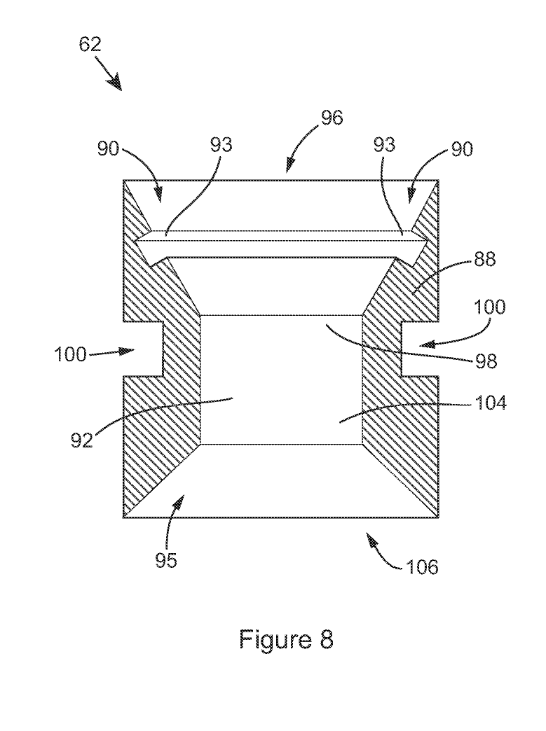

FIG. 8 shows a sectional view of a valve body of the valve nozzle of FIGS. 4 to 6;

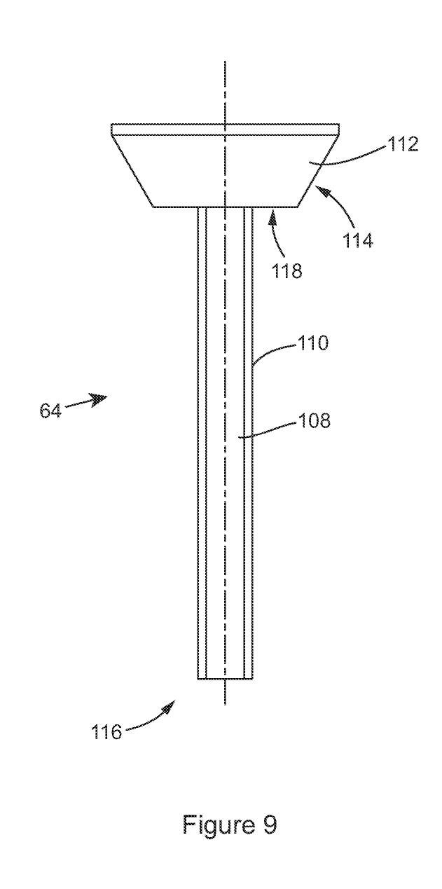

FIG. 9 shows a sectional view of a valve pin of the valve nozzle of FIGS. 4 to 6;

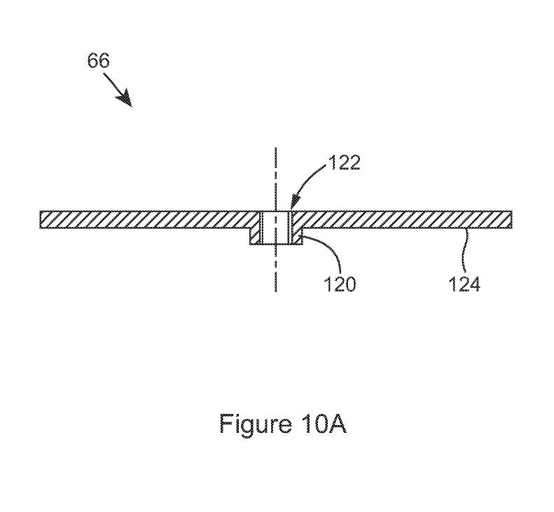

FIG. 10A shows a sectional view of an actuation plate of the valve nozzle of FIGS. 4 to 6;

FIG. 10B shows a sectional view of a valve ring of the valve nozzle of FIGS. 4 to 6;

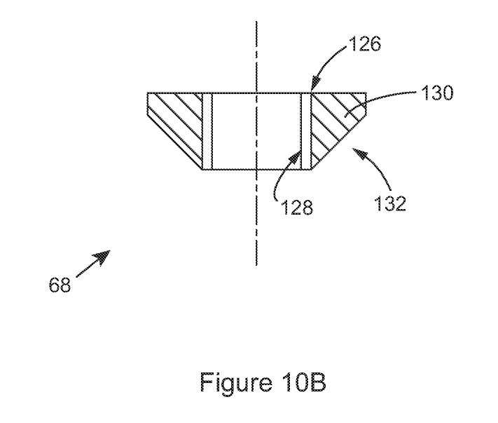

FIG. 11 shows a sectional view of an alternative valve nozzle for the system of FIG. 3 in a closed position;

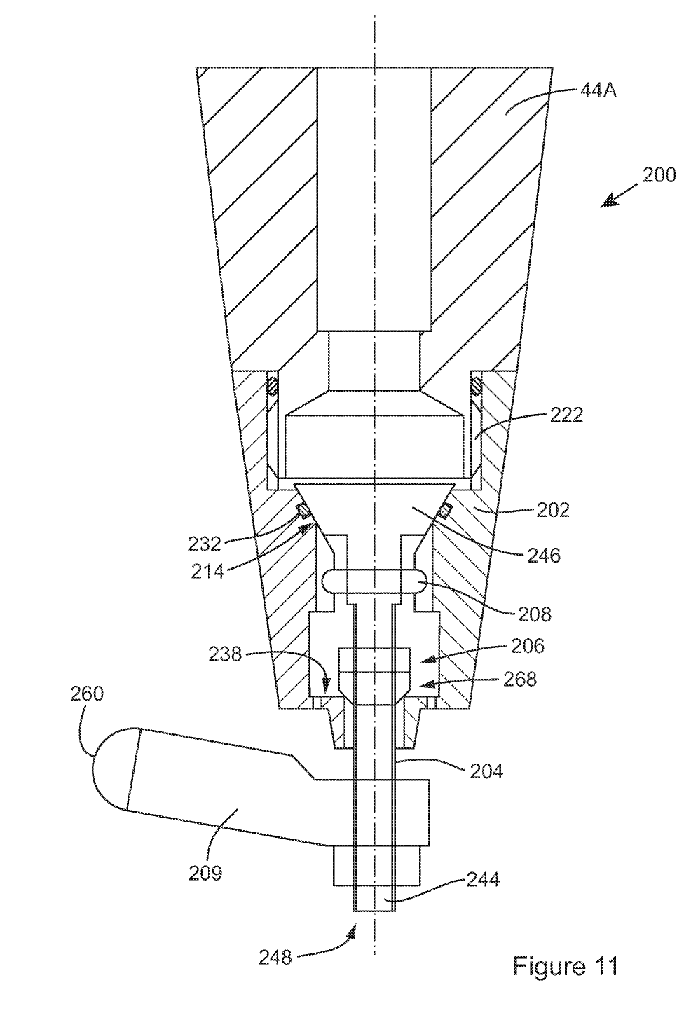

FIG. 12A shows a sectional view of a body of the valve nozzle of FIG. 11;

FIG. 12B shows a top down plan view of the body of the valve nozzle of FIG. 11;

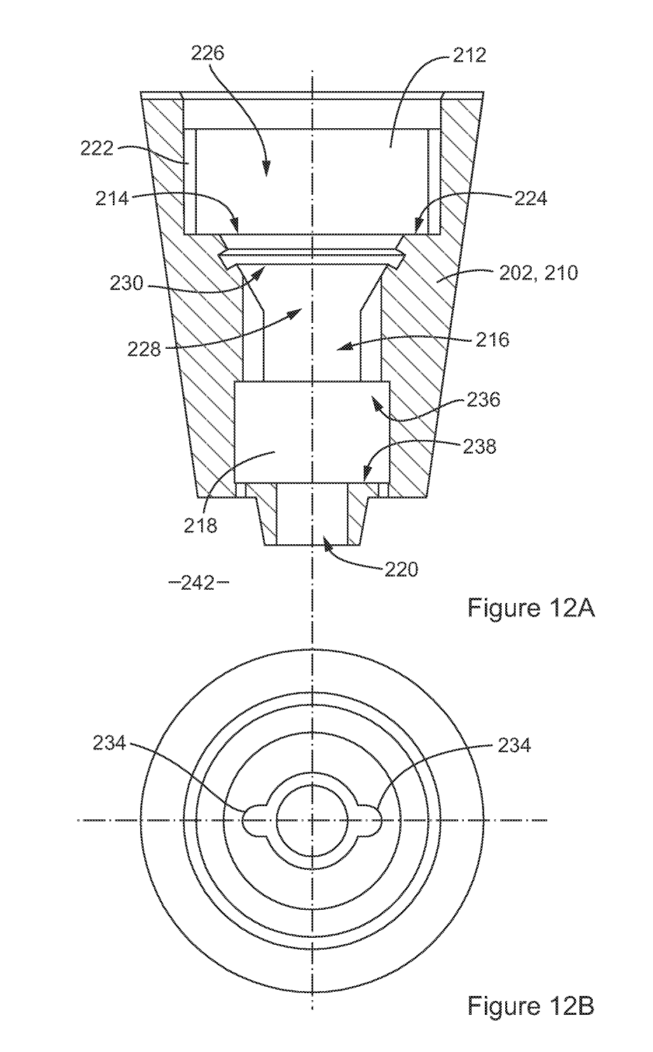

FIGS. 13A, 13B and 13C respectively show sectional views of a valve pin, a location pin and a valve ring of the valve nozzle of FIG. 11; and

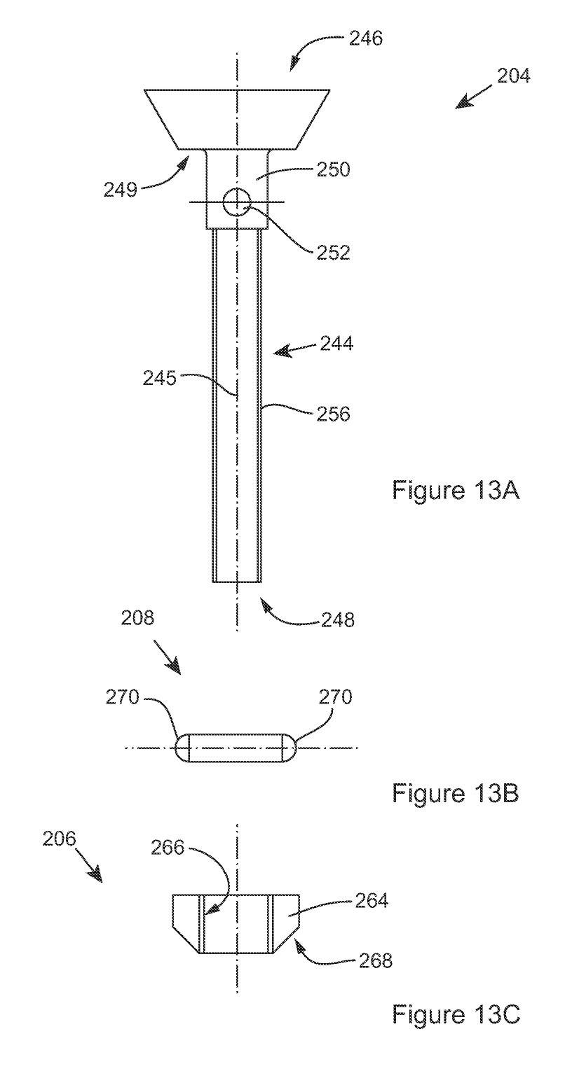

FIG. 14 shows a sectional view of a actuator bar of the valve nozzle of FIG. 11.

Referring firstly to FIG. 1, in a first embodiment of the invention, a system 2 for dispensing cask ale comprises a gas powered pump 4 drawing ale from a cask 6; a chiller 8; a shutoff valve 10; a tap 12; and a dispense conduit 14.

The cask 6 is of conventional type, being unpressurised and containing a cask ale (“real” ale) not shown in the drawings. The cask comprises a shive into which a soft spile has been knocked to allow ingress of air, as well as a cask tap from which ale can be drawn. The shive, spile and cask tap are conventional components and are not shown in FIG. 1. In a variant, the cask may be fitted with a cask breather, which allows a small amount of carbon dioxide to replace air in the cask. Cask breathers do not release enough carbon dioxide to carbonate the ale out of the cask, but just enough to blanket the ale to keep it fresher tasting for longer.

The cask tap is connected by a first section of ale line 16 to an inlet 18 of the pump 4. Ale lines are typically made of food-grade polymeric tubing, although other materials may also be suitable. Ale lines form conduits for ale, together with any other system components through which ale flows. The ale lines used in the exemplary embodiments of the invention were standard 9.53 mm (⅜ inch) diameter lines, although other diameters are also readily usable.

The pump 4 is a gas operated double diaphragm pump of conventional type, powered by pressurised carbon dioxide. The carbon dioxide is fed into the pump in known manner via a supply tube 20 at a controlled pressure from a carbon dioxide cylinder 22. The pressure of the carbon dioxide entering the pump is set to 80 psi by a gas pressure regulator 24, which is a relatively high pressure useful for drawing ale out of the cask 6 under suction and delivering it under a sustained pressure as will be described. As will be apparent to those skilled in the art, the carbon dioxide does not come into contact with the ale but merely actuates the pump 4. It is also possible to use other gas to power the pump 4.

Actuation of the pump 4 by the carbon dioxide causes ale to be sucked from the cask 6, into the first section of ale line 16 and the inlet 18 of the pump 4. Thereafter, the ale is released from an outlet 26 of the pump into a second section 28 of ale line, which carries it to a conventional commercial beverage chiller 8. The pump discharge pressure of the ale upon entering the second section of line 28 is about 80 psi and can be adjusted by varying the pressure of carbon dioxide entering the pump 4 using the gas pressure regulator 24. Actuation of the pump 4 can be stopped by stopping the supply of carbon dioxide.

Beverage chillers are known in the art for chilling keg beers, but are not normally used to chill cask ale, which tends to be served at ambient (cellar) temperature. Beverage chillers often comprise refrigerant coils and beverage conduits adjacent to each other in a water bath so that heat from the beverage flows into the water bath and refrigerant coils. A sensor may monitor the temperature of the water bath and is linked to control means which operate the refrigerant coils as necessary to maintain a desired temperature. The chiller 8 in the system 2 of FIG. 1 is shown schematically, without structural detail readily apparent to those skilled in the art. In the system 2 of FIG. 1, the chiller 8 is set to a temperature of 4 to 5° C. and thus cools the ale such that it exits the chiller 8 at this temperature.

Chilled ale exiting the chiller 8 is carried by a third section of ale line 30 through a conventional shutoff valve 10. The shutoff valve 10 is a simple, manually operable two-port “on/off” valve that can be opened to permit the flow of ale or shut to stop the flow of ale. It is disposed in the ale line 30 to permit convenient lockdown of the system, e.g. for cleaning of components downstream of the shutoff valve without switching off the pump 4.

From the shutoff valve 30, the third section of ale line 30 leads to the dispense tap 12, which is of the conventional free-flow type. Generally, free-flow taps comprise a housing or body defining a flow path for beverage from a pressurised line towards a dispensing outlet. The flow of beverage is regulated by a hand actuator in connection with a valve assembly, typically having valve barrel or head disposed within the housing along the flow path and including an annular valve surface or seal, e.g. of a rubbery material, that can be brought to bear against a mating annular valve seat also within the housing and disposed around a portion of the flow path, for creating a sealed condition which will prevent flow of the beverage and maintain pressurisation. The free-flow tap 12 in the system 2 of FIG. 1 is shown schematically, without structural detail readily apparent to those skilled in the art and acts as a flow regulator. It is used as the primary means for starting and stopping dispense of ale from the system 2 of this embodiment.

The tap 12 receives ale from the third section of ale line 30 into an inlet 32 at sustained line pressure, which is reduced from the 80 psi pump discharge pressure due to friction and elevational losses. When opened the tap 12 releases ale from an outlet 34 under a dispense pressure remaining with the range of from 18 to 24 psi directly into the dispense conduit 14. The pressure of 18 to 24 psi is set in this case by: the choice of pump discharge pressure; flow restrictions in the ale conduit, including friction, between the pump 4 and the free-flow tap 12; the elevation of the free-flow tap 12 relative to the pump 4; and the extent of any flow restriction in the tap 12 itself. Once the components of the system 2 are appropriately chosen and installed, the pump discharge pressure can be varied to fine-tune the dispense pressure to achieve the desired 18 to 24 psi (or, in alternative embodiments, another desired pressure profile). Though the pressure is sustained, it may be pulsed on account of oscillations of the pump 4.

The dispense conduit 14 is defined by a steel delivery tube 36 having an internal diameter of about 10 mm. Referring now also to FIG. 2, the delivery tube comprises a generally horizontal section 38 (about 70 mm in length) attached via a seal 40 to the outlet 34 of the free-flow tap 12, and a downward bend 42 leading to a generally vertical terminal section 44 (about 200 mm in length). At the end of the terminal section 44, the delivery tube 36 comprises an outlet 46, about 8 mm in diameter, at which is attached a sparkler nozzle 48. The terminal section 44 of the delivery tube 36 comprises a screw thread join 49, which cooperates with a screw thread of the sparkler nozzle 48 (not shown in FIG. 2).

Sparkler nozzles are known for dispensing cask ale using traditional handpumps, to produce a foam head. The sparkler nozzle 48 overlies and partially blocks the outlet 46 of the delivery tube, forcing the cask ale to be dispensed through sixteen small annularly arranged apertures (not shown) with a diameter of 0.7 mm which are formed in the nozzle 48. The nozzle thus defines a plurality of dispense outlets.

During operation of the system 2 according to the first embodiment of the invention, a stream of cask ale is drawn via the first section of line 16 into the pump 4, where it is pressurised and forced, at a pump discharge pressure of about 80 psi, into the second section of line 28, through the chiller 8 where it is chilled to a temperature of about 4 to 5° C., via the third section of line 30 and open shutoff valve 10, to the free-flow tap 12. When the free-flow tap 12 is open, the stream of ale flows at its dispense pressure in the range of from 18 to 24 psi into the dispense conduit 14, where it is turbulated and dispensed by the sparkler nozzle 48.

Dispensing the ale at a temperature of about 4 to 5° C. through the apertures of the sparkler nozzle 48 considerably turbulates (i.e. increases the turbulence of, or agitates) the cask ale as it is dispensed. At the relatively high dispense pressure in the range of from 18 to 24 psi, a pint of cask ale is dispensed, without any interruption in flow, through the sparkler nozzle 48 in less than ten seconds (e.g. as fast as nine seconds) and results in the formation of a tight, creamy foam head that persists for several minutes, e.g. at least five minutes. The system 2 thus allows cask ale to be served rapidly and with a consistent foam head, which in this preferred embodiment is a tight and creamy foam head not normally achieved by the more variable and slower dispense from a traditional hand pull.

Referring now to FIG. 3, in a second embodiment of the invention, a system 50 for dispensing cask ale comprises a gas powered pump 4 drawing ale from a cask 6; a chiller 8; a shutoff valve 10; a flow control valve 52; and a dispense conduit 14 comprising a valve nozzle outlet 54.

The cask 6, pump 4, chiller 8 and shutoff valve 10 of the system 50 according to the second embodiment of the invention are the same as in the system 2 according to the first embodiment of the invention. These components are also linked to each other identically by ale line sections 16, 28, 30. For a discussion of these components, reference is hence simply made to the foregoing description, with like reference numerals being used for like parts in FIG. 3.

From the shutoff valve 10, the third section 30 of ale line leads, in this second embodiment of the invention, to the flow control valve 52 which is housed in a font 56. The flow control valve 54 is pressure compensated and adjustable to release ale at a desired flow rate, which in turn corresponds to a desired dispense pressure. Pressure compensated flow control valves are known in the art to compensate for the effects of varying pressures to maintain a constant flow or output pressure. To provide a constant pressure drop across an orifice, and thus constant flow, a combination of two restrictors is typically used, one fixed and the other automatically variable. For example, an orifice sized to give a desired flow may be set by a needle restrictor and the pressure drop across this maintained constant by a compensating spool. In such an arrangement, any excessive pressure drop produced will typically act on the spool against a return bias to close a metering edge of the spool. This in turn reduces the flow through the valve as a whole, compensating the flow rate and output pressure to the desired level. The flow control valve 52 in the system 50 of FIG. 3 is shown schematically, without structural detail readily apparent to those skilled in the art. The flow control valve 52 acts as a flow regulator for the chilled ale, releasing it under a dispense pressure of about 24 psi, via a final section of ale line 58, into the dispense conduit. The pressure of 24 psi is set in this case by adjusting the setting of the flow control valve 52, or by selecting a suitable non-adjustable flow control valve 52.

The dispense conduit 14 is defined by a steel delivery tube 36 having an internal diameter of about 10 mm. The delivery tube 36 is identical to that described in respect of the first embodiment of the invention with reference to FIG. 2. The delivery tube comprises a generally horizontal section 38 (about 70 mm in length) attached to the final section of ale line 58 and a downward bend 42 leading to a generally vertical terminal section 44 (about 200 mm in length). At the end of the terminal section 44 of the delivery tube 36, the dispense conduit 14 comprises an outlet 46, about 8 mm in diameter, at which is attached, in this embodiment of the invention, the valve nozzle 54. The terminal section 44 of the delivery tube 36 comprises a screw thread join 49, which cooperates with a screw thread of the valve nozzle.

The valve nozzle 54 is the primary means for starting and stopping dispense of ale in the system 50 according to the second embodiment of the invention. It also represents, by itself, a third exemplary embodiment of the invention.

Referring to FIGS. 4 to 6, the valve nozzle 54 comprises a nozzle body 60, a valve body 62, a valve pin 64, a valve actuation plate 66 and a valve ring 68. Each of the components is formed of a suitable material, such as a metal or plastics.

With reference to FIG. 7, the nozzle body 60 of the valve nozzle comprises a nozzle wall 70 defining a cylindrical connection chamber 72 leading into a cylindrical valve body chamber 74, which in turn leads into a cylindrical nozzle bore 76. The chambers 72, 74 and the bore 76 are concentric, but the connection chamber 72 has the largest internal diameter, with the valve body chamber 74 having a smaller internal diameter and the nozzle bore 76 having a still smaller internal diameter. The connection chamber 72 comprises an internal screw thread 78 for connecting with the screw thread join 49 of the delivery tube 36.

The boundaries between the chambers 72, 74 and the bore 76 are defined by an upper shoulder 80 of the nozzle wall 70 between the connection chamber 72 and the valve body chamber 74 and a lower shoulder 82 of the nozzle wall 70 between the valve body chamber 74 and the nozzle bore 76. The lower shoulder 82 comprises a ring of sixteen small apertures 84 (about 0.7 mm in diameter) leading from the valve body chamber 74 to the outside 86 the nozzle body 60.

With reference to FIG. 8, the valve body 62 is generally annular and comprises a valve body wall 88 defining, internally, a valve seat 90, a valve bore 92 and a valve chamber 95. Externally, the valve body wall 88 is dimensioned to fit snugly and concentrically into the valve body chamber 74 of the nozzle body 60 to form a seal therewith. To assist the formation of the seal, the valve body wall comprises an annular groove 93 for receiving a rubber sealing ring 94 shown in FIGS. 4 to 6.

The valve seat 90 is funnel-shaped, tapering from a wider end 96, which is essentially of the same diameter as the valve body chamber 74 of the nozzle body 60, to a narrower end 98 at a boundary with the valve bore 92. The valve seat 90 also comprises an annular groove 100 for receiving a rubber sealing ring 102 shown in FIGS. 4 to 6.

The valve bore 92 is generally cylindrical and extends from the narrower end 98 of the valve seat 90 to the valve chamber 95. The valve chamber 95 has an inverse funnel shape, tapering from a narrower end 104 at the boundary with the valve bore 92 to a wider end 106 that is essentially of the same diameter as the valve body chamber 74 of the nozzle body 60.

With reference to FIG. 9, the valve pin 64 comprises a stem 108 having an external screw thread 110. At one end of the stem 108, the valve pin 64 comprises an integrally formed concentric valve disc 112 having a frustoconical section 114 for acting as a valve head that cooperates with the valve seat 90. The valve disc 112 tapers to a reduced diameter towards a free end 116 of the stem 108, from which it is demarcated by a shoulder 118.

The valve pin 64 is combined in use with the actuation plate 66 and valve ring 68. Referring now to FIGS. 10A and 10B, the actuation plate 66 comprises a hub 120 having an internal screw thread 122 for cooperating with the screw thread 110 of the stem 108 of the valve pin 64, and a radial regular disc 124 concentric with the hub 120. The valve ring 68 also comprises a hub 126 having an internal screw thread 128 for cooperating with the screw thread 110 of the stem 108 of the valve pin 64, but the hub 126 of the valve ring is integral with a disc 130 with a frustoconical section 132.

Referring again to FIGS. 4 to 6, to assemble the valve nozzle 54, the valve body 62 is initially fitted with rubber sealing rings 94, 102 in its internal and external annular grooves 93, 100. Thereafter, the stem 108 of the valve pin 64 is inserted into the annular valve body 62 from the end of the valve seat 90, such that the valve disc 112 engages the valve seat 90 and the stem 108 extends through the valve body bore 92 and emerges from the valve body chamber 95. The valve ring 68 is then screwed onto the stem 108 of the valve pin 64 to lie at the outer boundary of the valve body chamber 95, with the frustoconical section 132 of its disc 130 tapering towards the free end 116 of the stem 108. The valve body 62 with valve pin 64 is then inserted into the nozzle body 60 such that the valve body 62 forms a seal with the valve body chamber 74 of the nozzle body 60, with the free end 116 of the stem 108 of the valve pin 64 extending, through the nozzle bore 76, outside the nozzle body and the frustoconical section 132 of the valve ring 68 abutting the second shoulder 82 of the nozzle body 70. The actuation plate 66 is then affixed to the free end 116 of the stem 108 of the valve pin 64.

The valve nozzle 54 as a whole is attached, by means of the screw thread 78 in the connection chamber 72, to the terminal section 44 of the dispense tube 36 of the dispensing system 50 according to the second embodiment of the invention.

Referring now to FIG. 4, upon being attached to the dispense tube 36 and exposed to chilled ale (or other liquid) at a dispense pressure of about 24 psi, the valve disc 112 of the valve pin 64 is immediately forced by the pressure of the ale against the valve seat 90 of the valve body 62. The valve disc 112 forms a tight seal with the valve body 62 with the help of the rubber sealing ring 94 in the annular groove 93 of the valve seat 90. There is also a seal between the valve body 62 and the valve body chamber 74 of the nozzle body 60. Accordingly no ale passes the valve nozzle 54 and there is no dispense in this closed position.

With reference to FIG. 5, to dispense ale from the valve nozzle 54, the actuation plate 66 or the valve stem 108 can be pressed in an upstream direction, i.e. parallel to and towards the terminal section 44 of the dispense tube 36. This causes the actuation plate 66 to abut the nozzle body 60 and brings the valve 54 into a fully open position. In the fully open position, as the actuation plate 66 and the valve stem 108 are linked to the valve disc 112, the valve disc 112 is lifted upstream away from the valve seat 90 of the valve body 62. This allows the passage of ale along a flow path 134, through a gap 136 between the valve disc and the valve seat, into the valve body bore 92 and the valve body chamber 95, and out of the nozzle 54 through the small apertures 84 formed in the second shoulder 82 of the nozzle body 60. Ale is thus dispensed, relatively rapidly, from the valve nozzle 54 in the fully open position, which can be selected conveniently by pressing the stem 108 or the hub 120 of the actuation plate 66 against the bottom of a glass. The actuation plate 66 and stem 108 thus act as an actuator.

The valve nozzle 54 can also dispense ale in a partly open position by a tilting action of the valve pin 64. Referring to FIG. 6, if the actuation plate 66 is pressed laterally, i.e. generally orthogonal to the terminal section 44 of the dispense tube 36, the frustoconical section 132 of the valve ring 68 which abuts the second shoulder 82 of the nozzle body 60 translates the lateral motion of the actuation plate 66 into an upstream motion on one side of the valve pin 64. This lifts one side of the valve disc 112 slightly away from the valve seat 90. In this partly open position, a small amount of ale can pass along the flow path 134, through a small gap 136 between the valve disc 112 and the valve seat 90, into the valve body bore 92 and the valve body chamber 95, and out of the nozzle 54 through the small apertures 84 formed in the second shoulder 82 of the nozzle body 60. As the actuation plate 66 does not abut the nozzle body 60 in the partly open position, ale can also pass out of the nozzle 54 through the nozzle bore 76. Ale is thus dispensed from the valve nozzle 54 in the partly open position (more slowly than in the fully open position), which can be selected conveniently by pressing the disc 124 of the actuation plate 66 laterally with the side of a glass.

When the actuation plate 66 is not pressed externally, for example by a glass, the pressure of the ale forces the valve disc 112 back into the valve seat 90 to form a seal and prevent further dispense of ale. The closed position is thus the default position of the valve nozzle 54 as long as the ale is supplied to the valve nozzle 54 under pressure.

Referring again to FIG. 3, during operation of the system 50 according to the second embodiment of the invention, a stream of cask ale is drawn via the first section of line 16 into the pump 4, where it is pressurised and forced, at a pump discharge pressure of about 80 psi, into the second section of line 28, through the chiller 8 where it is chilled to a temperature of about 4 to 5° C., via the third section line 30 and opened shutoff valve 10, to the flow control valve 52. The flow control valve 52 regulates the pressure of the stream to 24 psi and passes it, via the final section of line 58, to the dispense conduit 14, where it is turbulated and dispensed when the valve nozzle 54 is in an open or partly open position.

Dispensing the ale at a temperature of about 4 to 5° C. through the apertures 84 of the valve nozzle 54 considerably turbulates (i.e. increases the turbulence of) the cask ale as it is dispensed. At the relatively high dispense pressure of 24 psi, a pint of cask ale is dispensed, without any interruption in flow, through the valve nozzle 54 in about nine seconds and results in the formation of a tight, creamy foam head that persists for several minutes, e.g. longer than five minutes. The system 50 thus allows cask ale to be served rapidly and with a consistent foam head, which in this case is a tight and creamy foam head not normally achieved by the more variable and slower dispense from a traditional hand pull.

The system 50 of the second embodiment of the invention offers additional advantages over the system 2 of the first embodiment of the invention. As the dispense pressure profile is substantially constant at about 24 psi, the system 50 of the second embodiment offers greater consistency. Furthermore, as described above, the valve nozzle 54 of the system 50 according to the second embodiment of the invention advantageously enables both rapid dispensing of ale and slower dispensing of ale, for example to top up a glass. Finally, the valve nozzle 54 also represents a particularly convenient means for starting and stopping dispense of ale, allowing for one-handed filling of glasses at the different selectable rates.

Whilst the valve nozzle 54 offers a particular synergy with the system 50 according to the second embodiment of the invention, naturally, the valve nozzle 54 is usable in other systems, e.g. in that of the first embodiment instead of or in addition to the free flow tap 12. The valve nozzle 54 can also be used in other dispensing systems, which may or may not be for beverages.

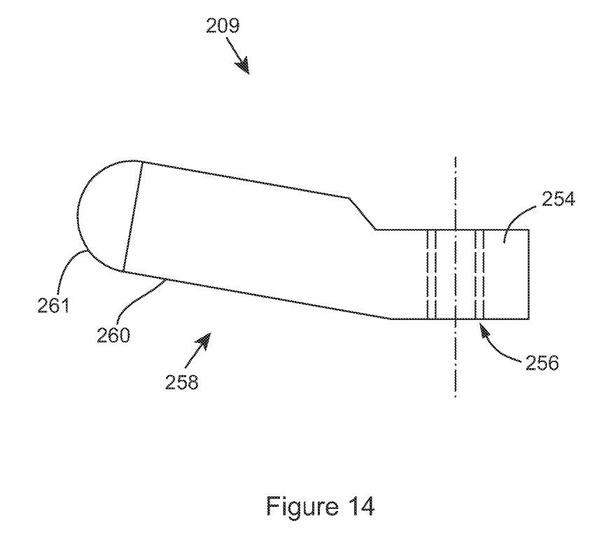

The valve nozzle 54 may be modified readily whilst maintaining its advantageous operation, or even to improve its operation further. In a fourth exemplary embodiment of the invention, and with reference to FIGS. 11 to 15, a valve nozzle 200 comprises: a body 202, a valve pin 204 co-operable with a valve ring 206 and a location pin 208, and a valve actuation bar 209. Each of the components is formed of a suitable material, such as a metal or plastics. The valve nozzle 200 of the fourth embodiment of the invention may be used, for example, instead of the valve nozzle 54 of the third embodiment of the invention in the system 2 according to the second embodiment of the invention.

With reference to FIGS. 12A and 12B, the body 202 of the valve nozzle 200 comprises a wall 210 defining a cylindrical connection chamber 212, a valve seat 214, a valve bore 216, a valve chamber 218 and a nozzle bore 220. The body 202 of the valve nozzle 200 is an integral component advantageously equivalent to a combination of the nozzle body 60 and the valve body 62 in the valve nozzle 54 third embodiment of the invention, though notably it also includes a further locational feature, as will be described.

From an upper end of the body 202 to a lower end, the connection chamber 212 leads to the valve seat 214, and this leads into the valve bore 216, which connects to the valve chamber 218, which in turn leads into the nozzle bore 220. The chambers 212, 218, bores 216, 220 and valve seat 214 are concentric, with the chambers 212, 218 and bores 216, 220 being generally cylindrical and the valve seat tapered, as will be described.

Of the chambers 212, 218 and bores 216, 220, the connection chamber 212 has the largest internal diameter. The connection chamber 212 comprises an internal screw thread 222 for connection, for example, to a modified terminal section 44A of the delivery tube 36 as illustrated in FIG. 11.

Referring still to FIGS. 12A and 12B, the boundary between the connection chamber 212 and the valve seat 214 is defined by an upper annular shoulder 224, from which the funnel-shaped valve seat 214 tapers radially inwards, from a wider upper end 226 to a narrower end 228 at a boundary with the valve bore 216. The valve seat 214 also comprises an annular groove 230 for receiving a rubber sealing ring 232 shown in FIG. 11.

The valve bore 216 extends from the narrower end 228 of the valve seat 214 to the valve chamber 218. Referring now particularly to FIG. 12B, whilst the valve bore 216 is generally cylindrical, it comprises first and second diametrically opposed rounded guide slots 234 for receiving the locating pin 208 as will be described. The guide slots 234 extend in an axial direction, from the valve seat 214 to the valve chamber 218 and are formed in a lower section of the valve seat 214 as well as in the wall 210 defining the valve bore 216.

The valve chamber 218 has a greater diameter than the valve bore 216 and accordingly meets the valve bore at an annular step 236. The difference in diameter between the valve chamber 218 and the valve bore 216, and hence the size of the step 236, is reduced in the area of the slots 234.

As aforesaid, the valve chamber 218 leads into the nozzle bore 220, which is of a smaller diameter than the valve chamber 218. The boundary of the valve chamber 218 and the nozzle bore 220 is defined by a lower annular shoulder 238, which comprises a ring of sixteen small apertures 240 (about 0.7 mm in diameter) leading from the valve chamber 218 to the outside 242 of the body 202.

Referring now to FIGS. 13A to 13C, the valve pin 204 comprises a stem 244 with a central axis 245 and having an external screw thread 246. At one end of the stem 244, the valve pin 204 comprises a frustoconical, integrally formed, concentric valve disc 246 for acting as a valve head that cooperates with the valve seat 214. The valve disc 246 tapers to a reduced diameter towards a free end 248 of the stem 244 and is demarcated from the stem by a shoulder 249. The stem 244 comprises a reinforced section 250 bounding the shoulder 248, and a transverse hole 252 for receiving the location pin 208 is formed therein.

The valve pin 204 is combined in use with the valve actuation bar 209, the valve ring 206 and the location pin 208. Referring now to FIG. 14, the valve actuation bar 209 comprises a hub 254 having an internal screw thread 256 for cooperating with the screw thread 246 of the stem 244 of the valve pin 204, and a radially extending arm 258. Whilst the hub 254 extends generally orthogonally to the axis of the screw thread 256 (which aligns with the axis 245 of the stem 244 in use), the arm 258 is angled with respect to the axis of the screw thread 256. The arm 258 comprises a surface 260 that lies at an obtuse angle to the axis of the stem 244 when the actuation bar 209 is secured to the stem 244 by the screw thread 256. The arm comprises a rounded end 261 to facilitate safe actuation of the actuation bar 209, for example with a glass (not shown).

With reference to FIG. 13C, the valve ring 206 also comprises a hub 264 having an internal screw thread 266 for cooperating with the screw thread 246 of the stem 244 of the valve pin 204, but the hub 264 of the valve ring 206 is integral with a disc 266 with a frustoconical section 268.

Referring to FIG. 13B, the location pin 208 is generally cylindrical with rounded ends 270 for being received in the rounded guide slots 234. The diameter of the location pin 208 is marginally less than the diameter of the transverse hole 252 in the valve pin 204 and its length is marginally less than the diameter of the valve bore 216 from slot 234 to slot 234.

Referring again to FIG. 11, to assemble the valve nozzle 200, the location pin 208 is first inserted into the transverse hole 252 of the valve pin 204, with the rounded ends 270 protruding. The valve ring 206 is screwed onto the stem 244 of the valve pin 204 so that it sits about three quarters of the way up the screw thread 256 of the valve pin 204. The valve pin 204 is then inserted into the annular body 202, which has been fitted with a rubber sealing ring 232, such that the valve disc 246 engages the valve seat 214. The free end 248 of the stem 244 of the valve pin 204 extends, through the nozzle bore 220, outside the nozzle body 202, with the frustoconical section 268 of the valve ring 206 abutting the lower shoulder 238 of the body 202. To enable such insertion, the protruding ends 270 of the location pin 208 must be located in the slots 234 in the valve seat 214 and the valve bore 216 for sliding engagement. Finally, the actuation bar 209 is affixed to the free end 248 of the stem 244 of the valve pin 204 by screwing it onto the screw thread 256 of the valve pin 204.

The valve nozzle 200 as a whole may be attached, by means of the screw thread 222 in the connection chamber 212, to the terminal section 44A of the dispense tube 36 of the dispensing system 50 according to the second embodiment of the invention.

The operation of the valve nozzle 200 works according to the same general principles as that of the valve nozzle 54 according to the third embodiment. Liquid pressure forces a seal between the valve disc 246 and the valve seat 214 unless the valve pin 204 is pushed upstream. This may occur by direct actuation in the upstream direction, which may bring the valve nozzle 200 into a fully open position, or by translated actuation following a tilting action of the valve pin 204, which brings the valve nozzle 200 into a partly open position. Tilting of the valve pin 204, which may conveniently be caused by lateral pushing of the actuation bar 209 e.g. with a glass, causes the frustoconical section 268 of the valve ring 206 to engage the lower shoulder 238 of the body 202, thereby pushing the valve pin 204 upstream and the valve disc 246 slightly away from the valve seat 214. Thus the valve nozzle 200 also conveniently offers two dispense speeds.

The actuation bar 209 of the valve nozzle 200 is particularly adapted for lateral actuation by virtue of its rounded end 260. Furthermore, the angled nature of the arm 258 of the actuation bar 209 contributes to the translation of lateral actuation into upstream movement of the valve pin 204 and allows residual liquid to flow towards a single axial drip point. The actuation bar 209 thus represents a particularly convenient and effective actuation component.

Spinning of the actuation bar 209 is prevented by the location of the ends 270 of the locating pin in the slots 234 of the body 202. Engagement by the locating pin 208 thus provides the valve nozzle 200 with additional stability and helps to guide translational movement of the valve pin 204 between closed and open positions.

1. A system for dispensing fermented beverage, the system comprising:
a supply of a fermented beverage that is extraneously unpressurized;
a pump configured for drawing fermented beverage by suction from said supply into a pump inlet and delivering fermented beverage from a pump outlet under sustained pressure;
a flow regulator having an inlet for receiving fermented beverage under sustained pressure from the pump outlet, and a flow regulator outlet for delivering fermented beverage under a dispense pressure; and
a dispense conduit for receiving fermented beverage under dispense pressure from the flow regulator outlet and turbulating and dispensing fermented beverage via the dispense outlet.

2. The system of claim 1 further comprising a chiller for chilling fermented beverage before it is dispensed via the dispense outlet, the chiller being arranged to chill fermented beverage to a temperature in the range of from 2 to 8° C. between the outlet of the pump and the inlet of the flow regulator.

3. (canceled)

4. The system of claim 1, wherein the flow regulator is operable to set the dispense pressure to conform to a predetermined dispense pressure profile such that the dispense pressure is kept substantially constant or within a pressure range whenever fermented beverage is dispensed.

5. The system of claim 1, wherein the dispense pressure is such that a pint of fermented beverage is dispensed from the dispense outlet at a substantially constant rate in less than 15 seconds.

6. (canceled)

7. The system of claim 1, wherein the dispense pressure remains in the range of from 14 to 28 psi.

8. The system of claim 1, wherein the flow regulator comprises a pressure compensated flow control valve.

9. The system of claim 1, wherein the flow regulator comprises a tap.

10. The system of claim 1, wherein the pump is configured to release fermented beverage under a discharge pressure of at least 80 psi.

11. (canceled)

12. The system of claim 1, wherein the dispense outlet is defined by a sparkler nozzle comprising a ring of apertures.

13. (canceled)

14. The system of claim 1 comprising a dispense valve operable to permit or prevent dispense of ale from the dispense outlet in an open and closed position respectively.

15. The system of claim 14, wherein the dispense valve is configured to be biased into the closed position by fermented beverage under dispense pressure.

16.-17. (canceled)

18. The system of claim 14, wherein the dispense valve comprises a valve nozzle defining a flow path for liquid from an inlet to a nozzle outlet, the valve nozzle comprising;
a valve seat extending about the flow path;
a valve head co-operable with the valve seat in a fully closed position to prevent flow of liquid along the flow path and out of the outlet;
an actuator connected to the valve head, the actuator being movable in a first direction to move the valve head away from the fully closed position to allow liquid to flow past the valve seat and along the flow path, and being movable in a second direction different to the first direction; and
deflecting means for translating movement of the actuator in the second direction into movement of the actuator in the first direction, such that movement of the actuator in the second direction causes the valve head to move away from the fully closed position to allow liquid to flow past the valve seat and along the flow path.

19. (canceled)

20. A method of dispensing fermented beverage from a dispense nozzle in fluid communication with a supply of fermented beverage, the method comprising: drawing a stream of fermented beverage from the supply; pressurizing the stream to force it along a transport conduit under sustained pressure; regulating the pressure of the transported stream to a dispense pressure; and turbulating and dispensing the stream from the dispense nozzle.

21. The method of claim 20 further comprising chilling the fermented beverage before it is dispensed to a temperature in the range of from 2 to 8° C.

22. The method of claim 20, wherein the dispense pressure is regulated such that a pint of beverage is dispensed at a substantially constant rate in less than 15 seconds.

23. (canceled)

24. The method of claim 20, wherein the dispense pressure is regulated to remain in the range of from 14 to 28 psi.

25.-26. (canceled)

27. A valve nozzle for dispensing liquid, the valve nozzle defining a flow path for liquid from an inlet to a nozzle outlet and comprising;
a valve seat extending around the flow path;
a valve head co-operable with the valve seat in a fully closed position to prevent flow of liquid along the flow path and out of the outlet;
an actuator connected to the valve head, the actuator being movable in a first direction to move the valve head away from the fully closed position to allow liquid to flow past the valve seat and along the flow path, and being movable in a second direction different to the first direction; and
deflecting means for translating movement of the actuator in the second direction into movement of the actuator in the first direction, such that movement of the actuator in the second direction causes the valve head to move away from the fully closed position to allow liquid to flow past the valve seat and along the flow path.

28. The valve nozzle of claim 27, wherein the deflecting means is arranged to tilt the valve head out of the fully closed position when the actuator is moved in the second direction.

29.-30. (canceled)

31. The valve nozzle of claim 27, wherein the actuator comprises a stem connected to the valve head, the stem comprising, or being connected to, a member accessibly clear of the flow path, wherein the stem comprises the deflecting means and the deflecting means comprises a formation that abuts a body of the valve when the valve head is in the fully closed position, the formation comprising a frustoconical section that abuts an internal shoulder of the valve body when the valve head is in the fully closed position, and engagement between the frustoconical section and the internal shoulder of the nozzle body translating movement of the actuator in the second direction into movement in the first direction.

32. (canceled)

33. The valve nozzle of claim 27, wherein the member comprises a disc or an arm having a surface that lies at an obtuse angle to an axis of translational movement of the stem.

34.-40. (canceled)
